(19) United States
(12) Patent Application Publication
(10) Pub. No.: US 2026/0197478 A1
(43) Pub. Date: Jul. 9, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih ESENLIK, Los Angelse, CA (US); Zhaobin Zhang, Los Angeles, CA (US); Meng Wang, Beijing (CN); Yaojun Wu, Beijing (CN); Kai Zhang, Los Angeles, CA (US); Li Zhang, Los Angeles, CA (US)

(21) Appl. No.: 19/551,473

(22) Filed: Feb. 26, 2026

Related U.S. Application Data
(63) Continuation of application No. PCT/CN2024/114330, filed on Aug. 23, 2024.

(30) Foreign Application Priority Data
Aug. 26, 2023 (WO) PCT/CN2023/115118

(51) Int. Cl. H04N 19/42; H04N 19/186; H04N 19/60

(52) U.S. Cl. CPC H04N 19/42; H04N 19/186; H04N 19/60

(57) ABSTRACT

Embodiments of the present disclosure provide a solution for visual data processing. A method for visual data processing is proposed. The method comprises: obtaining, for a conversion between visual data and a bitstream of the visual data with a neural network (NN)-based model, a format for coding the visual data, the format indicating a relationship between a size of a first component of the coded visual data and a size of a second component of the coded visual data, and a first synthesis transform in the NN-based model being used for the first component; determining, based on the format, a second synthesis transform in the NN-based model that is used for the second component; and performing the conversion based on the first synthesis transform and the second synthesis transform.

### CROSS REFERENCE TO RELATED APPLICATIONS

This application is a continuation of International Application No. PCT/CN2024/114330, filed on Aug. 23, 2024, which claims the benefit of International Application No. PCT/CN2023/115118, filed on Aug. 26, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: obtaining, for a conversion between visual data and a bitstream of the visual data with a neural network (NN)-based model, a format for coding the visual data, the format indicating a relationship between a size of a first component of the coded visual data and a size of a second component of the coded visual data, and a first synthesis transform in the NN-based model being used for the first component; determining, based on the format, a second synthesis transform in the NN-based model that is used for the second component; and performing the conversion based on the first synthesis transform and the second synthesis transform.

Based on the method in accordance with the first aspect of the present disclosure, the second synthesis transform for the second component of the visual data is determined based on the format for coding the visual data. Compared with the conventional solution where this coding format is fixed, the proposed solution can advantageously support different coding formats, so as to cater different applications. Thereby, the coding flexibility can be improved and thus the coding efficiency can be enhanced.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: obtaining a format for coding the visual data, the format indicating a relationship between a size of a first component of the coded visual data and a size of a second component of the coded visual data, and a first synthesis transform in a neural network (NN)-based model being used for the first component; determining, based on the format, a second synthesis transform in the NN-based model that is used for the second component; and generating the bitstream based on the first synthesis transform and the second synthesis transform.

In a fifth aspect, a method for storing a bitstream of visual data is proposed. The method comprises: obtaining a format for coding the visual data, the format indicating a relationship between a size of a first component of the coded visual data and a size of a second component of the coded visual data, and a first synthesis transform in a neural network (NN)-based model being used for the first component; determining, based on the format, a second synthesis transform in the NN-based model that is used for the second component; generating the bitstream based on the first synthesis transform and the second synthesis transform; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates an example synthesis transform for learning based image coding;

FIG. 10 illustrates an example LeakyReLU activation function;

FIG. 11 illustrates an example ReLU activation function;

FIG. 12 illustrates pixel shuffle and unshuffle operations;

FIG. 13 illustrates transposed convolution with a 2×2 kernel;

FIG. 14 illustrates an example of subsampled encoding/decoding scheme;

FIGS. 15A-15C illustrate examples of the proposed solutions, wherein different upsampling processes are performed for 4:4:4, 4:2:2 and 4:2:0 coding;

FIG. 16 illustrates an example of the second synthesis transform;

FIG. 17 illustrates an example first synthesis transform;

FIGS. 18A-18C illustrate example implementations of the proposed solution;

FIG. 19 illustrates an example implementation of the subpixel convolution unit;

FIGS. 20A-20C illustrate example implementations of the proposed solution;

FIG. 21 illustrates a flowchart of a method for visual data processing in accordance with embodiments of the present disclosure; and

FIG. 22 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

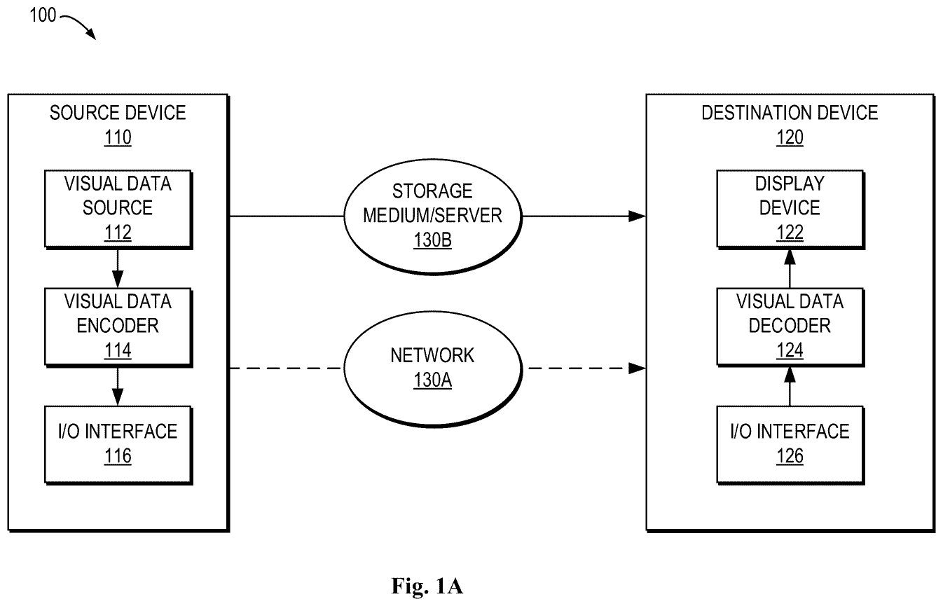

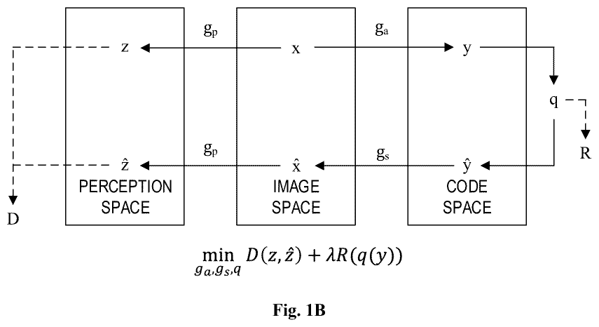

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1 Brief Summary

A neural image and video compression method comprising coding modes. The present disclosure is about an adaptive coding method, wherein a codec (encoder/decoder) is proposed that can perform 4:4:4 coding, 4:2:0 coding and 4:2:2 coding.

### 2 Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1 Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate—log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂ p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁.

Most of the methods directly model the probability distribution in the pixel domain. Some researchers also attempt to model the probability distribution as a conditional one upon explicit or latent representations. That being said, it may be estimated that

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks. FIG. 1B is an illustration of a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1B, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3 Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

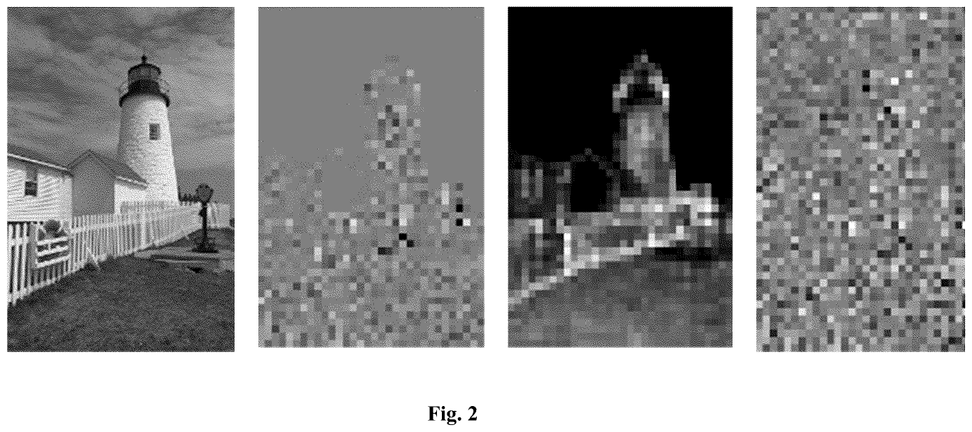

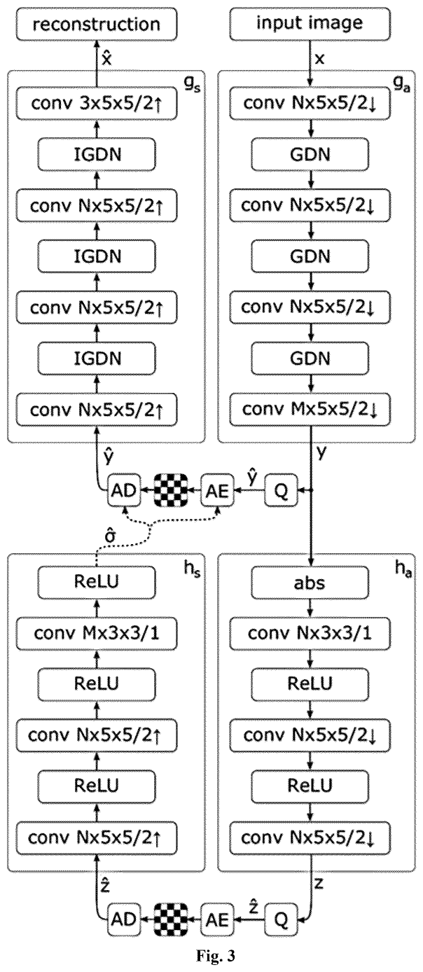

As evident from the middle left and middle right image of FIG. 2, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

With reference to FIG. 2: Left: an image from the Kodak dataset. Middle left: visualization of the latent representation y of that image. Middle right: standard deviations σ of the latent. Right: latents y after the hyper prior (hyper encoder and decoder) network is introduced.

FIG. 3 illustrates network architecture of an autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4 Context Model

Although the hyper prior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

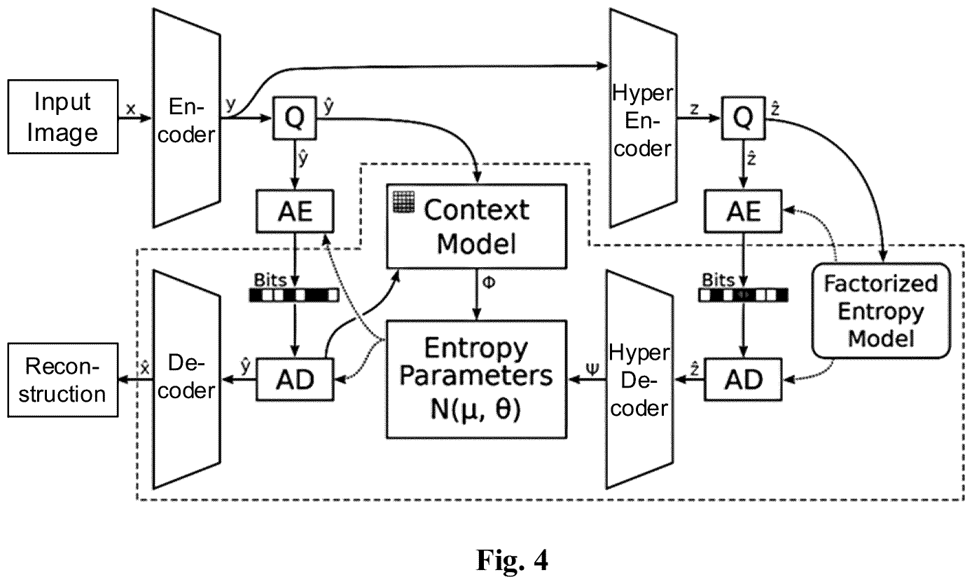

FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(·; θₑₚ) |
| Reconstruction | \hat{x} |

An existing deign utilizes a joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically the latent samples are modeled as gaussian distribution or gaussian mixture models (not limited to). In an existing design and according to the FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector:

$${\overline{y}}_{s} = y ⊙ {m}_{s}$$

where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as:

$${y}_{s}^{′} = \hat{y} ⊙ {m}_{s}^{′}$$

where ŷ is the decoded quantized latent representation and y′ₛ is the inversely gained quantized latent representation, which will be fed into the synthesis network.

To achieve continuous variable rate adjustment, interpolation is used between vectors. Given two pairs of gain vectors {mₜ, m′ₜ} and {mᵣ, m′ᵣ}, the interpolated gain vector can be obtained via the following equations:

$${m}_{ν} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 the Encoding Process Using Joint Auto-Regressive Hyper Prior Model

The FIG. 4. corresponds to the state of the art compression method. In this section and the next, the encoding and decoding processes will be described separately.

The FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module is used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent \grave{y} is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 5 are collectively called encoder. The analysis transform that converts the input image into latent representation is also called an encoder (or auto-encoder).

### 2.3.7 the Decoding Process Using Joint Auto-Regressive Hyper Prior Model

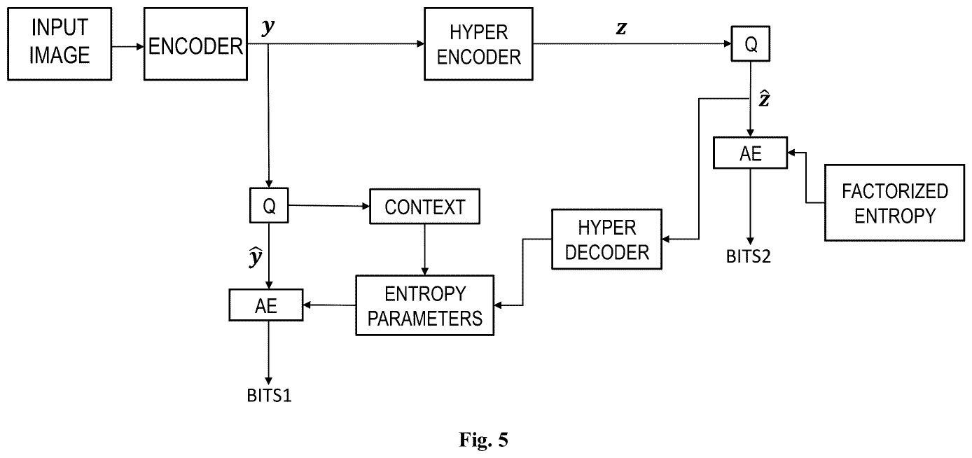

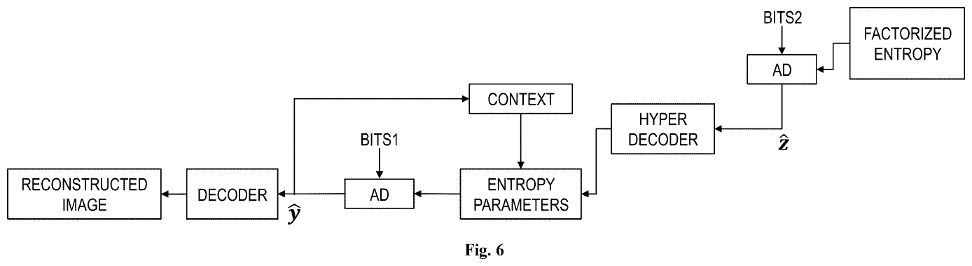

The FIG. 6 depicts the decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1,2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.6 Separate Processing of Luma and Chroma Components of an Image

FIG. 7 illustrates the decoding process according to the present disclosure.

According to one implementation, the luma and chroma components of an image can be decoded using separate subnetworks. In the Fig. above, the luma component of the image is processed by the subnetworks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of the above separate processing is that the computational complexity of the processing of an image is reduced by application of separate processing. Typically, in neural network-based image and video decoding, the computational complexity is proportional to the square of the number of feature maps. For example, if the number of total feature maps is 192, computational complexity will be proportional to 192×192. On the other hand, if the feature maps are divided into 128 for luma and 64 for chroma (in the case of separate processing), the computational complexity is proportional to 128×128+64×64, which corresponds to a reduction in complexity by 45%. Typically, the separate processing of luma and chroma components of an image does not result in a prohibitive reduction in performance, as the correlation between the luma and chroma components are typically very small.

The processing (Decoding process) in FIG. 7 can be explained below:
1. Firstly, the factorized entropy model is used to decode the quantized latents for luma and chroma, i.e., \hat{z} and \hat{z}ᵤᵥ in FIG. 7.
2. The probability parameters (e.g., variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all the samples of ŷ are obtained, a synthesis transform can be applied to obtain the reconstructed image.
6. For chroma component, steps 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural network based postprocessing module. The proposed solutions are not limited to the ICCI subnetwork, any other neural network based postprocessing module might also be used.

An exemplary implementation of the proposed solution is depicted in FIG. 7 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i, j].
4. The mean value mean[:, i, j] and the quantized residual latent ŵ[:, i, j] are added together to obtain the latent ŷ[:, i, j].
5. The steps 1-4 are repeated for the next sample.

Whether to and/or how to apply at least one method disclosed in the document may be signaled from the encoder to the decoder, e.g., in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in FIG. 7 might be an entropy decoding module. It might be a range decoder or an arithmetic decoder or the like.

The solutions described herein are not limited to the specific combination of the units exemplified in FIG. 7. Some of the modules might be missing and some of the modules might be displaced in processing order. In addition, additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+0 might be removed. The core of the proposed solutions is not affected by the removing of one or more of the said scaling and adding modules.

In the FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example, the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the number of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

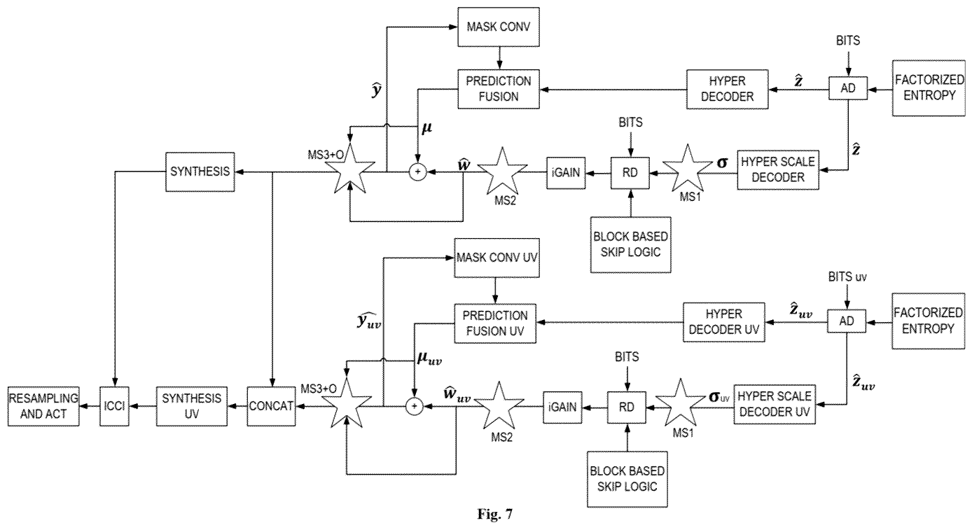

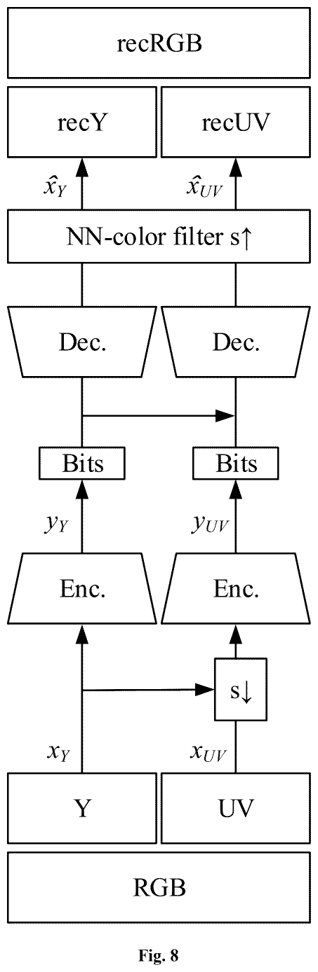

In one example the primary and secondary color components of an image are coded separately, using networks with similar architecture, but different number of channels as shown in FIG. 8. All boxes with same names are sub-networks with the similar architecture, only input-output tensor sizes and number of channels are different.

The number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

FIG. 8 illustrates learning-based image codec architecture.

First the input image that has RGB color format is converted to primary (Y) and secondary components (UV).

The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV}. The codec structure for primary component and secondary components are almost identical except for the number of channels, size of the channels and the several entropy models for transforming latent tensor to bitstream, therefore primary and secondary latent tensor will generate two different bitstreams based on two different entropy models. Prior to the encoding x_{Y}, x_{UV} goes through a module which adjusts the sample location by down-sampling (marked as “s↓” in FIG. 8), this essentially means that coded picture size for the secondary component is different from the coded picture size for the primary component. The scaling factor s is variable, but the default scaling factor is s=2. The size of auxiliary input tensor in conditional coding is adjusted in the order that the encoder receives primary and secondary components tensor with the same picture size. After reconstruction, the secondary component is rescaled to the original picture size with a neural-network based upsampling filter module (“NN-color filter s↑” in FIG. 8), which outputs secondary components up-sampled with factor s.

The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, \hat{x}_{UV} are converted back to RGB color format. Typically, the x_{UV} is downsampled (resized) before processing with the encoding and decoding modules (neural networks). For example, the size of the x_{UV} might be reduced by a factor of 50% in each of the vertical and horizontal dimensions. Therefore, the processing of the secondary component includes approximately 50%×50%=25% less samples, therefore it is computationally less complex.

### 2.8 Cropping Operation in Neural Network-Based Image/Video Coding

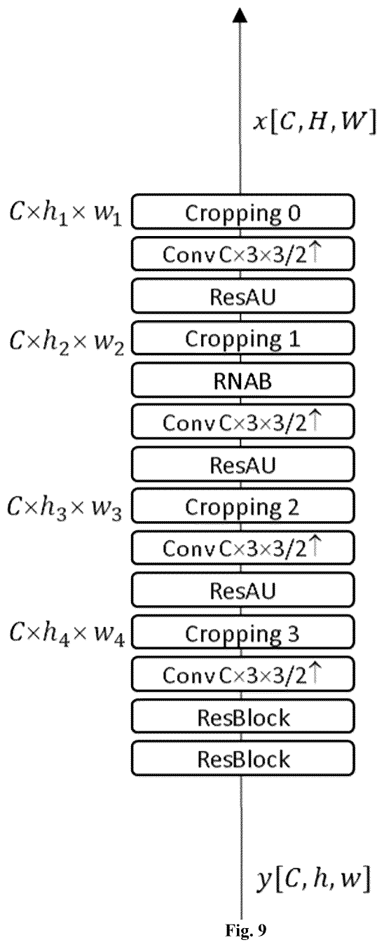

FIG. 9 illustrates Synthesis transform example for learning based image coding.

The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil(W/2^{d}); here d is the depth of proceeding convolution in the codec architecture. For primary component Synthesis Transform receives input tensor with size of h×w, where h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); wᵤᵥ=ceil(ceil(W/s)/16). The output of the Synthesis Transform for primary component is 2×h_{UV0}×w_{UV0}, where h_{UV0}=ceil(H/s); h_{UV0}=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depends on the output size H, W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers is controlled by the output size H, W. In one example if H and W are both equal to 16, then the cropping layers do not perform any cropping. On the other hand, if H and W are both equal to 17, then all 4 cropping layers are going to perform cropping.

### 2.9 Bitwise Shifting

The bitwise shift operator can be represented using the function bitshift (x, n), where n is an integer number. If n is greater than 0, it corresponds to right-shift operator (>>), which moves the bits of the input to the right, and the left-shift operator (<<), which moves the bits to the left. In other words, the bitshift(x, n) operation corresponds to:

$$bitshift ( x , n ) = x * {2}^{n}$$

$$or$$

$$bitshift ( x , n ) = floor ( x * {2}^{n} )$$

$$or$$

$$bitshift ( x , n ) = x // {2}^{n} .$$

The output of the bitshift operation is an integer value. In some implementations, the floor( ) function might be added to the definition. floor(x) is equal to the largest integer less than or equal to x.

The “//” operator or the integer division operator. It is an operation that comprises division and truncation of the result toward zero. For example, 7//4 is equivalent to 7/4 and truncated to 1, −7//(−4) is equivalent to −7/(−4) and truncated to 1. −7//4 is equivalent to −7/4 and truncated to −2; 7//(−4) is equivalent to 7/(−4) and truncated to −2.

$$rightshift ( x , n ) = x >> n$$

$$or$$

$$leftshift ( x , n ) = x << n$$

Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution is a simple operation at heart: you start with a kernel, which is simply a small matrix of weights. This kernel “slides” over the input data, performing an elementwise multiplication with the part of the input it is currently on, and then summing up the results into a single output pixel. In some cases the convolution operation might comprise a “bias”, which is added to the output of the elementwise multiplication operation.

The convolution operation might be described by the following mathematical formula. An output out1 can be obtained as:

$$[ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

wherein w1 are the multiplication factors, K1 is called a bias (an additive term) and Iₖ is the k^{th} input, and N is the kernel size in one direction and P is the kernel size in another direction. The convolution layer might consist of convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1$$

$$out [ c , x , y ] = conv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out [1,x,y] is one output and out [2,x,y] is a second output. Wherein the k is the input number, I[1, x, y] is one input and I[2, x, y] is a second input.

The w1, or w describe weights of the convolution operation.

### 2.10.1 2-Dimensional Convolution Operation

The convolution operation can be defined in 1, 2, 3, 4, . . . dimensions. As an example, the 2D convolution operation can be defined as:

$$out 1 [ x , y ] = conv 1 ( I ) = {\sum }_{i = 0}^{N} {\sum }_{j = 0}^{P} w {1}_{k} [ i , j ] \times {I}_{k} [ x + i , y + j ] + K 1$$

### 2.11 LeakyReLU Activation Function

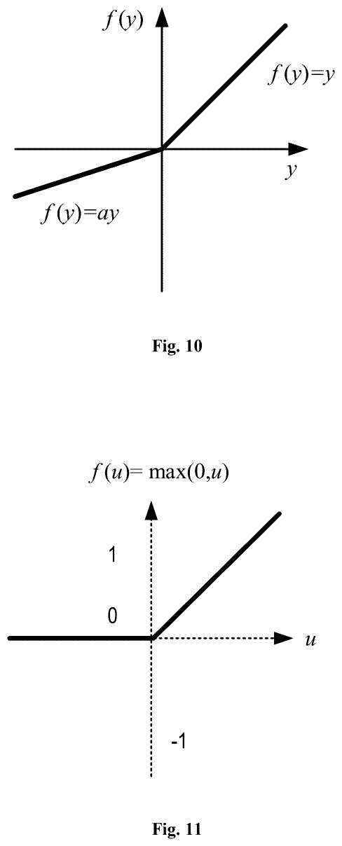

The LeakyReLU activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the LealyReLU function.

### 2.12 ReLU Activation Function

The ReLU activation function is depicted in FIG. 11. According to the function, if the input is a positive value, the output is equal to the input. If the input (y) is a non-positive value, the output is equal to 0.

### 2.13 Pixel Shuffle and Unshuffle Functions

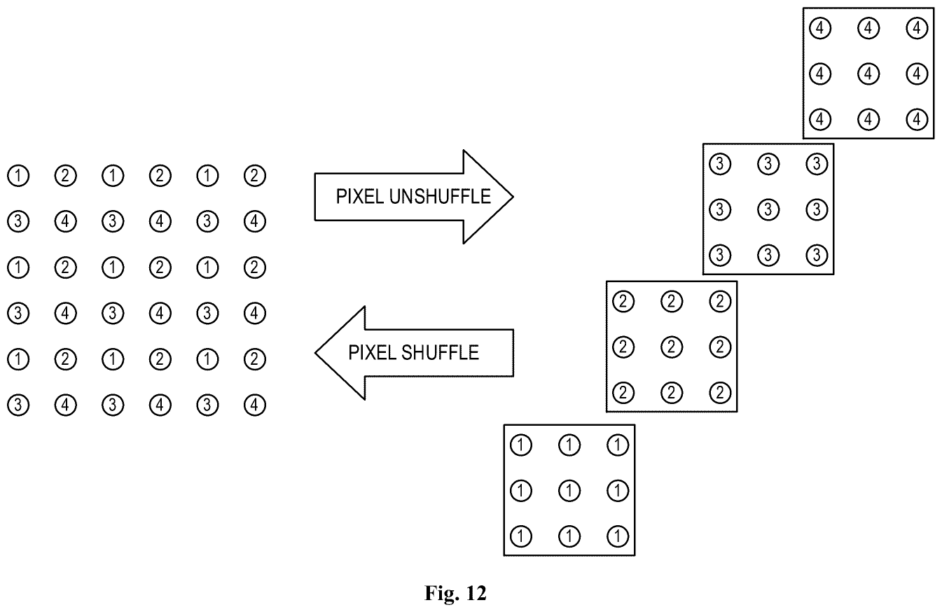

FIG. 12 depicts the pixel shuffle and unshuffle operations.

PixelShuffle is an operation used in super-resolution models to implement efficient sub-pixel convolutions with a stride of 1/r. Specifically it rearranges elements in a tensor of shape [C×r², W, H] to a tensor of shape [C, W×r, H×r].

Pixel unshuffled operation is the opposite of shuffle operation, wherein the input tensor with [C, W×r, H×r] is converted to a tensor with shape [C×r², W, H].

### 2.14 Deconvolution Operation

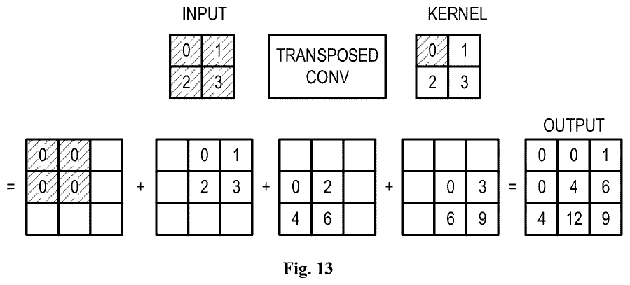

A transposed convolutional (aka deconvolution) layer is usually carried out for upsampling i.e., to generate an output feature map that has a spatial dimension greater than that of the input feature map. Transposed convolution operation is exemplified in FIG. 13.

FIG. 13 illustrates transposed convolution with a 2×2 kernel. The shaded portions are a portion of an intermediate tensor as well as the input and kernel tensor elements used for the computation.

### 3 Problems

3.1 The core problem

In state-of-the-art neural network based image and video codecs, the original input image might first be transformed to a different color format (e.g. YCbCr, YUV etc), and different color planes might be subsampled to increase the compression ratio. Typically, 3 input planes are used, for example Y, U and V correspond to different color planes. The 3 different planes might be encoded/decoded with the same spatial size, or some of the planes might be subsampled (reduction in spatial size) before encoding.

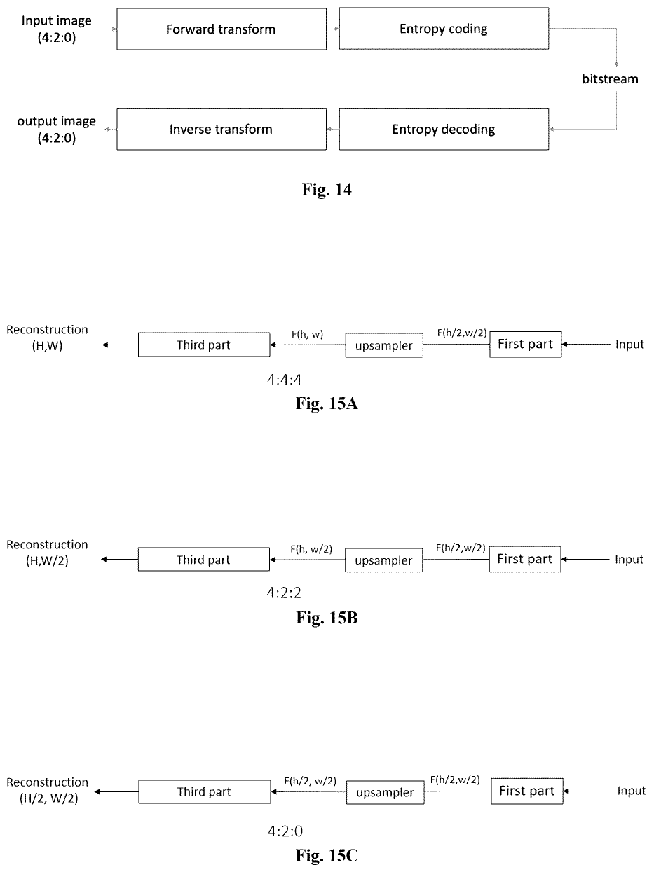

FIG. 14 illustrates an example of subsampled encoding/decoding scheme.

One such encoding/decoding scheme is exemplified in FIG. 14. According to Fig. the input image has a format of 4:2:0. (4:2:0) is a notation indicating that the input image has dimensions as follows:
First component (first plane) has dimensions of H and W, wherein H is height and W is width.
The second and third component (planes) have dimensions of H/2 and W/2. The dimensions of second and third components are reduced, since they are chroma components and they comprise less information pertaining to the human visual system (e.g. they are less relevant to the human perception).

On the other hand, it is not always beneficial to use 4:2:0 subsampling and compression. The information comprised in the second and the third component are sometimes important, and it might be desirable to keep that information. The processes of encoding and decoding are lossy operations, especially in terms of the 4:2:0 coding, causing loss of information that cannot be later retrieved.

The problem is therefore the lack of adaptive coding method for neural network-based encoding/decoding systems.

In the rest of the document the following definitions are used:

4:4:4 coding: the primary and secondary components of an image have same size as input to encoding process and as output of the decoding process.

4:2:0 coding: the primary and secondary components of an image have different sizes as input to encoding process and as output of the decoding process. If the size of the first component is H×W (height×width), the size of the secondary components is

$$\frac{H}{2} \times \frac{W}{2} .$$

4:2:2 coding: the primary and secondary components of an image have different sizes as input to encoding process and as output of the decoding process. If the size of the first component is H×W (height×width), the size of the secondary components is

$$H \times \frac{W}{2} or \frac{H}{2} \times W .$$

### 4 Detailed Solutions

The present disclosure is about an adaptive coding method, wherein a codec (encoder/decoder) is proposed that can perform 4:4:4 coding, 4:2:0 coding and 4:2:2 coding.

### 4.1 Core of Detailed Solutions

According to some embodiments of the present disclosure, one bitstream is generated by the encoder, and transmitted to the decoder. The decoder comprises 2 synthesis transforms. The first synthesis transform operates on the first component. And the second synthesis transform operates on the second component. Wherein;
The second synthesis transform comprises 3 parts: a first part, an upsampler unit and third part.
The upsampler unit is configured according to the coding mode (e.g. 4:4:4, 4:2:0 or 4:2:2).
Optionally the third part of the synthesis transform can be configured according to the coding mode. FIGS. 15A-15C illustrate examples of the proposed solutions, wherein different upsampling processes are performed for 4:4:4, 4:2:2 and 4:2:0 coding.

The proposed solutions are exemplified in FIGS. 15A, 15B and 15C. According to the coding mode, an upsampler unit is performed.
When the coding mode is 4:4:4 (corresponding to FIG. 15A), the upsampler unit might be configured to do upsampling in both horizontal and vertical directions. The output of first part has spatial dimension of h/2 by w/2. After the unsampled by the upsampler unit, the spatial dimensions become h by w. Finally, after the processing by the third part, the spatial dimensions become H by W.
When the coding mode is 4:2:2 (corresponding to FIG. 15B), the upsampler unit might be configured to do upsampling in only horizontal or in only vertical direction. The output of the first part has spatial dimension of h/2 by w/2. After the unsampled by the upsampler unit, the spatial dimensions become h by w/2. Finally, after the processing by the third part, the spatial dimensions become H by W/2.
When the coding mode is 4:2:0 (corresponding to FIG. 15C), the upsampler unit might be configured to do no upsampling. The output of the first part has spatial dimension of h/2 and w/2. After the unsampled by the upsampler unit, the spatial dimensions are still h/2, w/2. Finally, after the processing by the third part, the spatial dimensions become H/2, W/2.
   In one example the second synthesis transform might not include the said upsampler unit, since it is redundant.

### 4.2 Details of Detailed Solutions

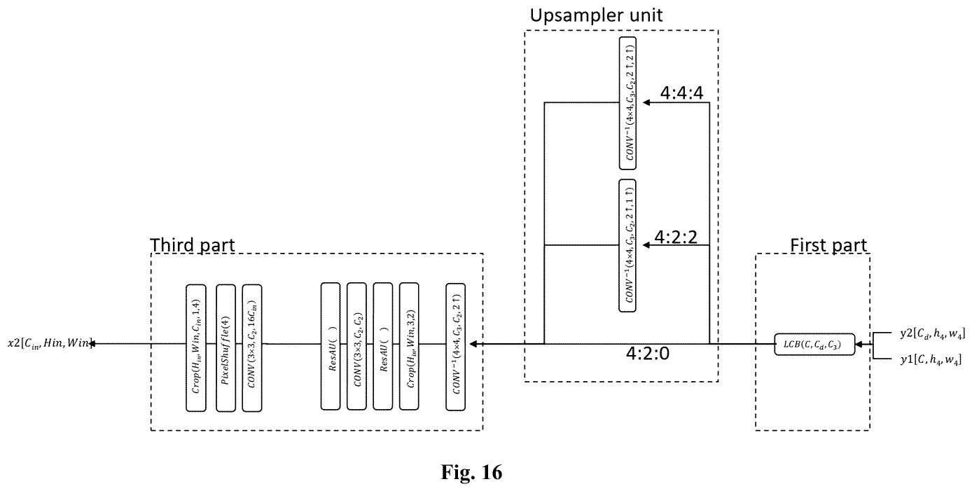

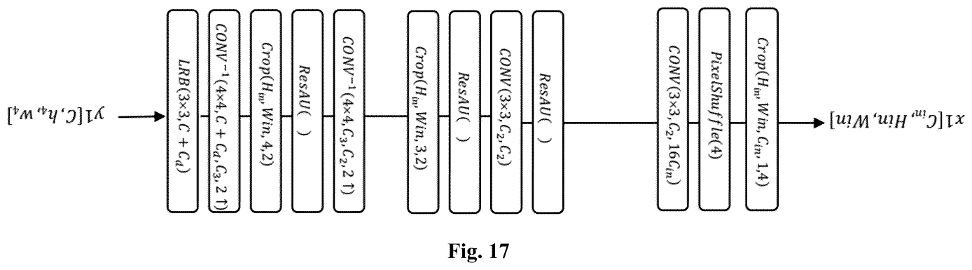

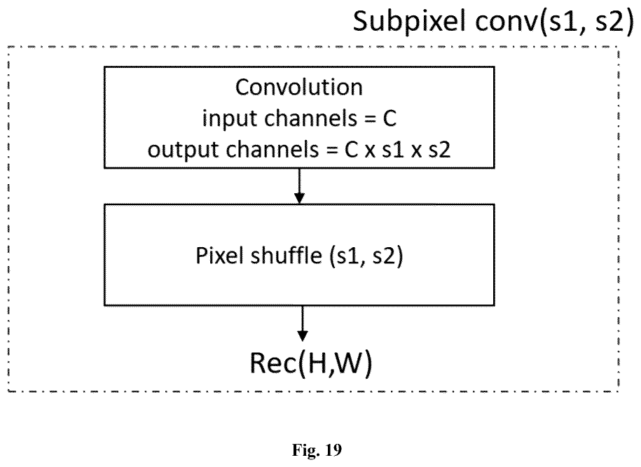

According to some embodiments, a first synthesis transform might be used to process the primary component, and its structure might be the same for different coding modes (4:4:4, 4:2:0 or 4:2:2).
According to some embodiments, the second synthesis transform might be used to process the secondary component, and its structure might be different for different coding modes (4:4:4, 4:2:0 or 4:2:2).
   More specifically an upsampler unit might be configured differently for different coding modes.
The vertical and horizontal sizes of the inputs of the first and second synthesis transforms might be the same.
   The inputs of the first and second synthesis transforms might be same.
   A same input might be input to the first and the second synthesis transforms.
According to the some embodiments, the output of the second synthesis transform might be a component of a reconstructed image.
   The component might be a chroma component.
The upsampler unit might be implemented with a deconvolution layer, a transposed convolution layer, a pixel shuffle layer, or a nearest sample upsampling layer.
   In nearest sample upsampling layer, the size of the input tensor is increased by copying nearest sample values or interpolating the nearest samples to the newly generated sample positions (that are generated by increasing the size of the tensor).
   In the case of deconvolution or transposed convolution, the stride might be different for different coding modes. The horizontal stride or the vertical stride or both them of the deconvolution (or transposed convolution) might be modified based on the coding mode.
An example of the second synthesis transform might be depicted in FIG. 16. In the example the first part of the synthesis transform, the third part and the upsampler units are encapsulated in dashed boxes. According to the example based on the coding mode, different branches might be used during the processing with synthesis transform.
   For example, if the coding mode is 4:2:0, the bottom branch might be used wherein no upsampling is performed.
   For example, if the coding mode is 4:2:2, the middle branch might be traversed, wherein 2× upsampling is performed only in the vertical direction or horizontal direction. This is depicted by the deconvolution layer: CONV⁻¹ (4×4, C₃, C₂, 2↑, 1↑), In the deconvolution layer (denoted CONV⁻¹), two stride values are defined (2↑, 1↑), one corresponding to upsampling ratio in one dimension, and the second one corresponding to upsampling ratio in second dimension.
   For example, if the coding mode is 4:4:4, the top branch might be traversed, wherein 2× upsampling is performed both in the vertical direction or horizontal directions.
An example first synthesis transform might be depicted in FIG. 17. In the example the first synthesis transform is not changed based on the coding mode.
The inputs of the first and second synthesis might be same. In FIGS. 17 and 16, one of the inputs (i.e. y1 [C, h4, w4]) is same for both synthesis transforms. The second synthesis transform receives a second input y2 [C, h4, w4] additionally.
The inputs of the first and second synthesis might be different. The intermediate or final output of the first synthesis might be used in the second synthesis.
Alternatively, or additionally the second synthesis transform might be composed of two parts. A front part and an upsampling unit at the end.
   In one example the upsampling unit might be a subpixel convolution unit.
      The subpixel convolution unit might comprise two layers, a convolution layer and a pixel shuffle layer. An example implementation of the subpixel convolution unit is depicted in FIG. 19.
      The implementation of a pixel shuffle layer might be described as follows:
      pixel shuffle layer, is denoted as PixelShuffle(s), where s>1 is the upscale factor. This layer rearranges elements in a tensor input of shape [Cᵢₙ, hᵢₙ, wᵢₙ] to a tensor output of shape [Cₒᵤₜ, hₒᵤₜ, wₒᵤₜ], where hₒᵤₜ=s·hᵢₙ; wₒᵤₜ=s·wᵢₙ; Cₒᵤₜ=Cᵢₙ/s². For c=0 . . . . Cₒᵤₜ−1, i=0 . . . hₒᵤₜ−1 and j=0 . . . . wₒᵤₜ−1,

$$output [ c , i , j ] = input [ c \cdot {s}^{2} + ( i \% s ) \cdot s + j \% s , i / s , j / s ] .$$

pixel shuffle layer, is denoted as PixelShuffle(s1, s2), where s1≥1, s2≥1 is the upscale factor. This layer rearranges elements in a tensor input of shape [Cᵢₙ, hᵢₙ, wᵢₙ] to a tensor output of shape [Cₒᵤₜ, hₒᵤₜ, wₒᵤₜ], where hₒᵤₜ=s1·hᵢₙ; wₒᵤₜ=s2·wᵢₙ; Cₒᵤₜ=Cᵢₙ/s1·s2.
For c=0 . . . . Cₒᵤₜ−1, i=0 . . . hₒᵤₜ−1 and j=0 . . . . wₒᵤₜ−1,

$$output [ c , i , j ] = input [ c \cdot s 1 \cdot s 2 + ( i \% s 1 ) \cdot s 2 + j \% s 2 , i / s 1 , j / s 2 ] .$$

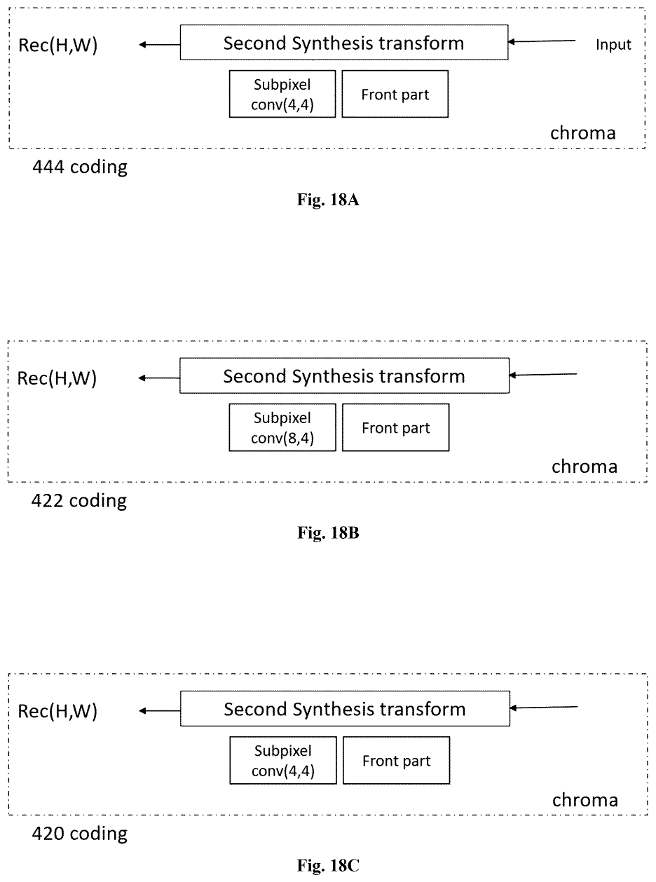

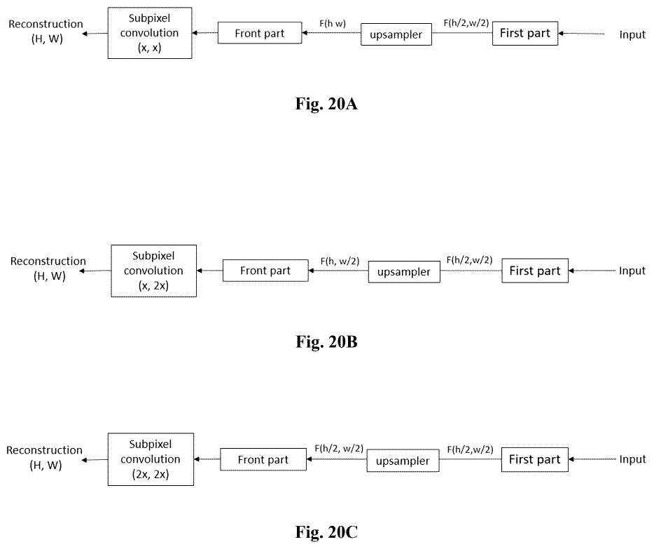

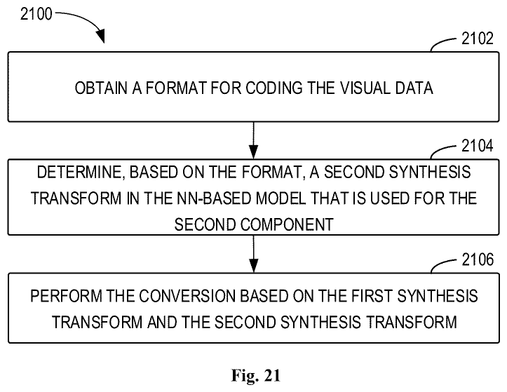

An example implementation might be depicted in FIGS. 18A, 18B and 18C.
The second synthesis transform might be configured based on the coding mode.
   The subpixel convolution unit might be configured based on the coding mode.
   The subpixel convolution unit might be controlled by one or two upsampling ratios:
      Subpixel conv(s1, s2), wherein the upsampling ratios are s1 and s2.
      Subpixel conv(s), wherein the upsampling ratio is s.
      The upsampling ratios of the subpixel convolution might be controlled according to the coding mode.
      The output channel number of the convolution layer of the subpixel convolution unit might be controlled according to the coding mode.
According to some embodiments, the second synthesis transform might comprise 4 parts:
   First part,
   Upsampling unit (upsampler),
   Front part,
   Subpixel convolution part,
   An example implementation might be depicted in FIGS. 20A, 20B and 20C.
   The upsampling unit and the subpixel convolution part might be controlled based on the coding mode.
Signaling
   An indication might be included in the bitstream to indicate the coding mode.
   An indication might be included in the bitstream to indicate a picture format. The control of the second synthesis transform might be based on such indication.
   An indication might be included in the bitstream to indicate a picture color coding format. The control of the second synthesis transform might be based on such indication.
Upsampling ratio utilized by the upsampling unit might be 2×.

### 4.3 Explanation and the Benefits of the Proposed Solutions

The present disclosure provides a solution for supporting different coding modes with very limited change to the synthesis transforms.

It is important to support different coding modes, as different coding modes cater to different applications. The most typical image/video coding application requires usage of 4:2:0 coding mode, as it is the coding mode that is most efficient in terms of compression efficiency. In other words, the quality of the image in terms of human visual perception is best at the same bitrate (same number of bits used) when coding mode is 4:2:0. However 4:2:0 coding mode is not always enough for every application.

For example, when the preservation of the original material is important, it is necessary to use 4:4:4 or 4:2:2 coding modes instead of the 4:2:0 coding mode. For example, if the image to be coded is a medical image, or it has artistic intention it becomes necessary to use 4:4:4 or 4:2:2 coding modes.

Supporting different coding modes would typically require substantial change in the codec (decoder and/or encoder). The present disclosure provides a solution wherein different coding modes can be supported with minimal modifications. More specifically, the proposed solution does not change the input of the second transform. As a result, entropy decoding pipeline that is necessary for generating the input of the second synthesis transform is not changed. Furthermore, the first synthesis transform that is responsible for decoding of the first component of the image is also unchanged.

Finally, the modifications in the second synthesis transform are very limited. As a result, the different coding modes catering different applications can be supported with limited modifications thanks to the proposed solutions.

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design for neural network (NN)-based visual data coding, a format of the output of the entire synthesis transform is always a 4:2:0 format, i.e., it is fixed. In a case where a format of the output of the whole decoding process is desired to be a format different from the 4:2:0 format, a filter (such as a Bicubic filter or the like) shall be applied to the output of the entire synthesis transform. Therefore, this conventional solution cannot support different formats of the output of the entire synthesis transform, and thus lacks flexibility.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

FIG. 21 illustrates a flowchart of a method 2100 for visual data processing in accordance with some embodiments of the present disclosure. The method 2100 may be implemented during a conversion between the visual data and a bitstream of the visual data with a neural network (NN)-based model. As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

As shown in FIG. 21, the method 2100 starts at 2102, where a format for coding the visual data is obtained. As used herein, the format for coding the visual data may refer to a format of the output of the entire synthesis transform (which may comprise one or more synthesis transforms) in the NN-based model. This format for coding the visual data may also be referred to as “first format”, “coding format”, “coded format”, “coded image format”, “coding mode”, and/or the like. The input of an analysis transform at an encoder side may also be of this format. It should be noted that this format is allowed to be different from a format of an output of the conversion (i.e., the output of the entire decoding process). The format of the output of the entire decoding process may also be referred to as “second format”, “output format”, “output image format” and/or the like. It should also be noted that the term “format” may also be referred to as “color format” or the like. In some embodiments, the first format may be indicated by at least one indication in the bitstream. In this case, the first format may be obtained by parsing the bitstream. Additionally or alternatively, the second format may be indicated by at least one indication in the bitstream. Moreover, the first format may be determined based on the second format or any other suitable coding information for the visual data. In some embodiments, the first format may be the same as the second format. Additionally or alternatively, the first format and the second format may be indicated by same indication(s) in the bitstream.

The format for coding the visual data indicates a relationship between a size of a first component of the coded visual data and a size of a second component of the coded visual data. For example, the format for coding the visual data may indicate a ratio between a vertical size (e.g., height) of the first component and a vertical size (e.g., height) of the second component, and/or a ratio between a horizontal size (e.g., width) of the first component and a horizontal size (e.g., width) of the second component. Similarly, the format of the output of the entire decoding process may indicate a relationship between a size of a first component of the output of the entire decoding process and a size of a second component of the output of the entire decoding process. For example, the format of the output of the entire decoding process may indicate a ratio between a vertical size (e.g., height) of the first component and a vertical size (e.g., height) of the second component, and/or a ratio between a horizontal size (e.g., width) of the first component and a horizontal size (e.g., width) of the second component.

In some embodiments, the format for coding the visual data may be allowed to be a 4:4:4 format, a 4:2:0 format, a 4:2:2 format, or the like. In addition, the format of the output of the entire decoding process may be allowed to be a 4:4:4 format, a 4:2:0 format, or a 4:2:2 format, or the like. By way of example, for a 4:4:4 format, the vertical size of the second component may be the same as the vertical size of the first component, and the horizontal size of the second component may be the same as the horizontal size of the first component. For a 4:2:2 format, the vertical size of the second component may be a half of the vertical size of the first component, and the horizontal size of the second component may be the same as the horizontal size of the first component. Alternatively, the vertical size of the second component may be the same as the vertical size of the first component, and the horizontal size of the second component may be a half of the horizontal size of the first component. For a 4:2:0 format, the vertical size of the second component may be a half of the vertical size of the first component, and the horizontal size of the second component may be a half of the horizontal size of the first component. In some embodiments, the first component may comprise one of the following: a primary component, a luma component, or a Y component, and the second component may comprise one of the following: a secondary component, a chroma component, a U component, or a V component. It should be understood that the above examples are described merely for purpose of description. The scope of the present disclosure is not limited in this respect.

It is seen that, a ratio between a vertical size of the first component and a vertical size of the second component may be allowed to be 1 or 2, and a ratio between a horizontal size of the first component and a horizontal size of the second component may be allowed to be 1 or 2. It should be understood that the specific values recited herein are intended to be exemplary rather than limiting the scope of the present disclosure.

A first synthesis transform in the NN-based model may be used for the first component, and a second synthesis transform in the NN-based model may be used for the second component. For example, the first synthesis transform and the second synthesis transform may also be regarded as two parts of an entire synthesis transform. In this case, an output of the first synthesis transform and an output of the second synthesis transform may constitute the output of the entire synthesis transform. In some embodiments, the first synthesis transform may comprise a lightweight residual block (LRB), a convolution layer, a cropping layer, a residual activation unit (ResAU), a shuffle layer, and/or the like.

At 2104, a second synthesis transform in the NN-based model that is used for the second component is determined based on the format for coding the visual data (referred to as “first format” hereinafter). In some embodiments, one or more parameters of the second synthesis transform may be configured based on the first format. This will be described in detail below. Additionally or alternatively, a structure of the second synthesis transform may be configured based on the first format. By way of example rather than limitation, a structure of the second synthesis transform may be configured differently from different formats.

In some embodiments, the first synthesis transform may be the same for different formats. That is, the first synthesis transform may be independent from the first format. Alternatively, the first synthesis transform may also be determined based on the first format. The scope of the present disclosure is not limited in this respect.

At 2106, the conversion is performed based on the first synthesis transform and the second synthesis transform. In some embodiments, the conversion may include encoding the visual data into the bitstream. Additionally or alternatively, the conversion may include decoding the visual data from the bitstream. It should be understood that the above illustrations are described merely for purpose of description. The scope of the present disclosure is not limited in this respect.

In view of the above, the second synthesis transform for the second component of the visual data is determined based on the format for coding the visual data. Compared with the conventional solution where this coding format is fixed, the proposed solution can advantageously support different coding formats, so as to cater different applications. Thereby, the coding flexibility can be improved and thus the coding efficiency can be enhanced.

In some embodiments, the second synthesis transform may comprise an upsampling subnetwork (also referred to as “upsampler unit” herein). At least one parameter of the upsampling sub-network may be configured based on the first format. For example, the at least one parameter of the upsampling subnetwork may be configured differently for different formats. In one example embodiment, the upsampling subnetwork may comprise a shuffle layer, and the at least one parameter may comprise at least one scale factor of the shuffle layer. By way of example rather than limitation, a vertical scale factor of the shuffler layer may be determined based on a ratio between the vertical size of the first component and the vertical size of the second component. Additionally or alternatively, a horizontal scale factor of the shuffler layer may be determined based on a ratio between the horizontal size of the first component and the horizontal size of the second component. In some additional or alternative example embodiments, the upsampling subnetwork may comprise a deconvolution layer, a transposed convolution layer, a nearest sample upsampling layer, and/or the like.

By way of example rather than limitation, if the first format is a 4:4:4 format, the upsampling subnetwork may apply an upsampling operation in both horizontal and vertical directions. If the first format is a 4:2:2 format, the upsampling subnetwork may apply an upsampling operation merely in one of the horizontal and vertical directions. If the first format is a 4:2:0 format, the upsampling subnetwork does not apply an upsampling operation in the horizontal and vertical directions.

In some embodiments, the second synthesis transform may further comprise a first subnetwork (also referred to as “first part” herein) preceding the upsampling subnetwork. For example, the first subnetwork may comprise a latent combine block (LCB). Additionally, the first subnetwork may also comprise a convolution layer, a shuffler layer, a cropping layer, a residual activation unit (ResAU), and/or the like. By way of example rather than limitation, at least one parameter of the first subnetwork may be configured based on the first format.

In addition, or alternatively, the second synthesis transform may further comprise a second subnetwork (also referred to as “third part” herein) following the upsampling subnetwork. For example, the second subnetwork may comprise a cropping layer. Additionally, the second subnetwork may also comprise a convolution layer, a shuffler layer, a cropping layer, a residual activation unit (ResAU), and/or the like. By way of example, the second synthesis transform may further comprise a subpixel convolution unit preceding the upsampling subnetwork. For example, the subpixel convolution unit may comprise a convolution layer and a shuffle layer. By way of example rather than limitation, at least one parameter of the second subnetwork may be configured based on the first format. For example, a parameter of the cropping layer may be dependent on the first format.

In some embodiments, an input of the first synthesis transform may be different from an input of the second synthesis transform. By way of example rather than limitation, the input of the second synthesis transform may comprise the input of the first synthesis transform and a further input. For example, the input of the second synthesis transform may be obtained by concatenating the input of the first synthesis transform and a further input. In some embodiments, a vertical size of the input of the first synthesis transform may be the same as a vertical size of the input of the second synthesis transform, and a horizontal size of the input of the first synthesis transform may be the same as a horizontal size of the input of the second synthesis transform. Additionally, the number of channels of the input of the first synthesis transform may be different from the input of the second synthesis transform. Alternatively, a vertical size of the input of the first synthesis transform may be different from a vertical size of the input of the second synthesis transform, and/or a horizontal size of the input of the first synthesis transform may be different from a horizontal size of the input of the second synthesis transform. In some alternative embodiments, the input of the first synthesis transform may be the same as the input of the second synthesis transform.

In some embodiments, an output of the second synthesis transform may be a chroma component of reconstructed visual data. Additionally, an output of the first synthesis transform may be a luma component of reconstructed visual data. In this case, the output of the entire synthesis transform comprising the first and second synthesis transforms may be the reconstructed visual data.

In some embodiments, a size of an output of the second synthesis transform may be determined based on the first format. For example, the size of the output of the second synthesis transform may comprise a width and/or a height of the output of the second synthesis transform. In one example embodiment, the size of the output of the second synthesis transform may be equal to a size of an output of the first synthesis transform. In a further example embodiment, the size of the output of the second synthesis transform may be equal to a half of a size of an output of the first synthesis transform.

By way of example rather than limitation, if the first format is a 4:4:4 format, the width of the output of the second synthesis transform may be equal to a width of an output of the first synthesis transform, and the height of the output of the second synthesis transform may be equal to a height of the output of the first synthesis transform. If the first format is a 4:2:2 format, the width of the output of the second synthesis transform may be equal to the width of an output of the first synthesis transform, and the height of the output of the second synthesis transform may be equal to a half of the height of the output of the first synthesis transform. If the first format is a 4:2:0 format, the width of the output of the second synthesis transform may be equal to a half of the width of an output of the first synthesis transform, and the height of the output of the second synthesis transform may be equal to a half of the height of the output of the first synthesis transform.

In some embodiments, the size of the output of the second synthesis transform may be determined based on an indication obtained from the bitstream, such as the at least one indication indicating the first format.

In view of the above, the solutions in accordance with some embodiments of the present disclosure can advantageously support different coding formats, so as to cater different applications. Thereby, the coding flexibility can be improved and thus the coding efficiency can be enhanced.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: obtaining a format for coding the visual data, the format indicating a relationship between a size of a first component of the coded visual data and a size of a second component of the coded visual data, and a first synthesis transform in a neural network (NN)-based model being used for the first component; determining, based on the format, a second synthesis transform in the NN-based model that is used for the second component; and generating the bitstream based on the first synthesis transform and the second synthesis transform.

According to still further embodiments of the present disclosure, a method for storing bitstream of visual data is provided. The method comprises: obtaining a format for coding the visual data, the format indicating a relationship between a size of a first component of the coded visual data and a size of a second component of the coded visual data, and a first synthesis transform in a neural network (NN)-based model being used for the first component; determining, based on the format, a second synthesis transform in the NN-based model that is used for the second component; generating the bitstream based on the first synthesis transform and the second synthesis transform; and storing the bitstream in a non-transitory computer-readable recording medium.

Implementations of the present disclosure can be described in view of the following clauses, the features of which can be combined in any reasonable manner.

Clause 1. A method for visual data processing, comprising: obtaining, for a conversion between visual data and a bitstream of the visual data with a neural network (NN)-based model, a format for coding the visual data, the format indicating a relationship between a size of a first component of the coded visual data and a size of a second component of the coded visual data, and a first synthesis transform in the NN-based model being used for the first component; determining, based on the format, a second synthesis transform in the NN-based model that is used for the second component; and performing the conversion based on the first synthesis transform and the second synthesis transform.

Clause 2. The method of clause 1, wherein the first synthesis transform is the same for different formats.

Clause 3. The method of any of clauses 1-2, wherein the second synthesis transform comprises an upsampling subnetwork, and at least one parameter of the upsampling sub-network is configured based on the format.

Clause 4. The method of clause 3, wherein the at least one parameter of the upsampling subnetwork is configured differently for different formats.

Clause 5. The method of any of clauses 3-4, wherein the upsampling subnetwork comprises a shuffle layer.

Clause 6. The method of clause 5, wherein the at least one parameter comprises at least one scale factor of the shuffle layer.

Clause 7. The method of any of clauses 3-6, wherein the second synthesis transform further comprises a first subnetwork preceding the upsampling subnetwork, and the first subnetwork comprises a latent combine block (LCB).

Clause 8. The method of any of clauses 3-7, wherein the second synthesis transform further comprises a second subnetwork following the upsampling subnetwork, and the second subnetwork comprises a cropping layer.

Clause 9. The method of clause 8, wherein at least one parameter of the second subnetwork is configured based on the format.

Clause 10. The method of any of clauses 1-9, wherein an input of the first synthesis transform is different from an input of the second synthesis transform.

Clause 11. The method of clause 10, wherein a vertical size of the input of the first synthesis transform is the same as a vertical size of the input of the second synthesis transform, and a horizontal size of the input of the first synthesis transform is the same as a horizontal size of the input of the second synthesis transform.

Clause 12. The method of any of clauses 1-11, wherein an output of the second synthesis transform is a chroma component of reconstructed visual data.

Clause 13. The method of any of clauses 1-12, wherein a size of an output of the second synthesis transform is determined based on the format.

Clause 14. The method of clause 13, wherein the size of the output of the second synthesis transform comprises at least one of a width or a height of the output of the second synthesis transform.

Clause 15. The method of any of clauses 13-14, wherein the size of the output of the second synthesis transform is equal to a size of an output of the first synthesis transform.

Clause 16. The method of any of clauses 13-14, wherein the size of the output of the second synthesis transform is equal to a half of a size of an output of the first synthesis transform.

Clause 17. The method of clause 14, wherein if the format is a 4:4:4 format, the width of the output of the second synthesis transform is equal to a width of an output of the first synthesis transform, and the height of the output of the second synthesis transform is equal to a height of the output of the first synthesis transform, or if the format is a 4:2:2 format, the width of the output of the second synthesis transform is equal to the width of an output of the first synthesis transform, and the height of the output of the second synthesis transform is equal to a half of the height of the output of the first synthesis transform, or if the format is a 4:2:0 format, the width of the output of the second synthesis transform is equal to a half of the width of an output of the first synthesis transform, and the height of the output of the second synthesis transform is equal to a half of the height of the output of the first synthesis transform.

Clause 18. The method of clauses 13-17, wherein the size of the output of the second synthesis transform is determined based on an indication obtained from the bitstream.

Clause 19. The method of any of clauses 1-18, wherein the format is indicated by at least one indication in the bitstream.

Clause 20. The method of any of clauses 3-19, wherein a ratio between a vertical size of the first component and a vertical size of the second component is allowed to be 2, and a ratio between a horizontal size of the first component and a horizontal size of the second component is allowed to be 2.

Clause 21. The method of any of clauses 1-20, wherein the first synthesis transform comprises at least one of the following: a lightweight residual block (LRB), a convolution layer, a cropping layer, a residual activation unit (ResAU), or a shuffle layer.

Clause 22. The method of any of clauses 1-21, wherein the first component comprises one of the following: a primary component, a luma component, or a Y component, and the second component comprises one of the following: a secondary component, a chroma component, a U component, or a V component.

Clause 23. The method of any of clauses 1-22, wherein the format is allowed to be one of the following: a 4:4:4 format, a 4:2:0 format, or a 4:2:2 format.

Clause 24. The method of any of clauses 3-23, wherein if the format is a 4:4:4 format, the upsampling subnetwork applies an upsampling operation in both horizontal and vertical directions, or if the format is a 4:2:2 format, the upsampling subnetwork applies an upsampling operation merely in one of the horizontal and vertical directions, or if the format is a 4:2:0 format, the upsampling subnetwork does not apply an upsampling operation in the horizontal and vertical directions.

Clause 25. The method of any of clauses 1-24, wherein a structure of the second synthesis transform is configured differently from different formats.

Clause 26. The method of any of clauses 1-9, wherein an input of the first synthesis transform is the same as an input of the second synthesis transform.

Clause 27. The method of any of clauses 3-4, wherein the upsampling subnetwork comprises at least one of the following: a deconvolution layer, a transposed convolution layer, or a nearest sample upsampling layer.

Clause 28. The method of any of clauses 3-6, wherein the second synthesis transform further comprises a subpixel convolution unit preceding the upsampling subnetwork.

Clause 29. The method of clause 28, wherein the subpixel convolution unit comprises a convolution layer and a shuffle layer.

Clause 30. The method of any of clauses 1-29, wherein the visual data comprise a video, a picture of the video, or an image.

Clause 31. The method of any of clauses 1-30, wherein the conversion includes encoding the visual data into the bitstream.

Clause 32. The method of any of clauses 1-30, wherein the conversion includes decoding the visual data from the bitstream.

Clause 33. An apparatus for visual data processing comprising a processor and a non-transitory memory with instructions thereon, wherein the instructions upon execution by the processor, cause the processor to perform a method in accordance with any of clauses 1-32.

Clause 34. A non-transitory computer-readable storage medium storing instructions that cause a processor to perform a method in accordance with any of clauses 1-32.

Clause 35. A non-transitory computer-readable recording medium storing a bitstream of visual data which is generated by a method performed by an apparatus for visual data processing, wherein the method comprises: obtaining a format for coding the visual data, the format indicating a relationship between a size of a first component of the coded visual data and a size of a second component of the coded visual data, and a first synthesis transform in a neural network (NN)-based model being used for the first component; determining, based on the format, a second synthesis transform in the NN-based model that is used for the second component; and generating the bitstream based on the first synthesis transform and the second synthesis transform.

Clause 36. A method for storing a bitstream of visual data, comprising: obtaining a format for coding the visual data, the format indicating a relationship between a size of a first component of the coded visual data and a size of a second component of the coded visual data, and a first synthesis transform in a neural network (NN)-based model being used for the first component; determining, based on the format, a second synthesis transform in the NN-based model that is used for the second component; generating the bitstream based on the first synthesis transform and the second synthesis transform; and storing the bitstream in a non-transitory computer-readable recording medium.

### Example Device

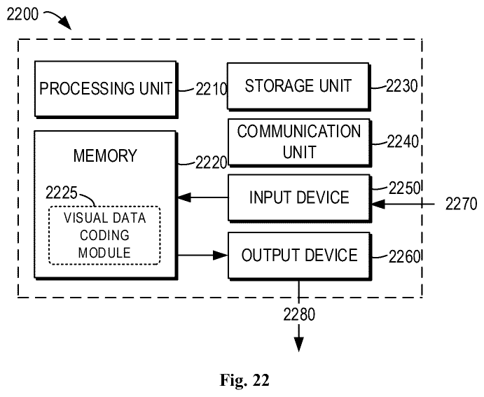

FIG. 22 illustrates a block diagram of a computing device 2200 in which various embodiments of the present disclosure can be implemented. The computing device 2200 may be implemented as or included in the source device 110 (or the visual data encoder 114) or the destination device 120 (or the visual data decoder 124).

It would be appreciated that the computing device 2200 shown in FIG. 22 is merely for purpose of illustration, without suggesting any limitation to the functions and scopes of the embodiments of the present disclosure in any manner.

As shown in FIG. 22, the computing device 2200 includes a general-purpose computing device 2200. The computing device 2200 may at least comprise one or more processors or processing units 2210, a memory 2220, a storage unit 2230, one or more communication units 2240, one or more input devices 2250, and one or more output devices 2260.

In some embodiments, the computing device 2200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2200 can support any type of interface to a user (such as “wearable” circuitry and the like).

The processing unit 2210 may be a physical or virtual processor and can implement various processes based on programs stored in the memory 2220. In a multi-processor system, multiple processing units execute computer executable instructions in parallel so as to improve the parallel processing capability of the computing device 2200. The processing unit 2210 may also be referred to as a central processing unit (CPU), a microprocessor, a controller or a microcontroller.

The computing device 2200 typically includes various computer storage medium. Such medium can be any medium accessible by the computing device 2200, including, but not limited to, volatile and non-volatile medium, or detachable and non-detachable medium. The memory 2220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2230 may be any detachable or non-detachable medium and may include a machine-readable medium such as a memory, flash memory drive, magnetic disk or another other media, which can be used for storing information and/or visual data and can be accessed in the computing device 2200.

The computing device 2200 may further include additional detachable/non-detachable, volatile/non-volatile memory medium. Although not shown in FIG. 22, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 2240 communicates with a further computing device via the communication medium. In addition, the functions of the components in the computing device 2200 can be implemented by a single computing cluster or multiple computing machines that can communicate via communication connections. Therefore, the computing device 2200 can operate in a networked environment using a logical connection with one or more other servers, networked personal computers (PCs) or further general network nodes.

The input device 2250 may be one or more of a variety of input devices, such as a mouse, keyboard, tracking ball, voice-input device, and the like. The output device 2260 may be one or more of a variety of output devices, such as a display, loudspeaker, printer, and the like. By means of the communication unit 2240, the computing device 2200 can further communicate with one or more external devices (not shown) such as the storage devices and display device, with one or more devices enabling the user to interact with the computing device 2200, or any devices (such as a network card, a modem and the like) enabling the computing device 2200 to communicate with one or more other computing devices, if required. Such communication can be performed via input/output (I/O) interfaces (not shown).

In some embodiments, instead of being integrated in a single device, some or all components of the computing device 2200 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2200 may be used to implement visual data encoding/decoding in embodiments of the present disclosure. The memory 2220 may include one or more visual data coding modules 2225 having one or more program instructions. These modules are accessible and executable by the processing unit 2210 to perform the functionalities of the various embodiments described herein.

In the example embodiments of performing visual data encoding, the input device 2250 may receive visual data as an input 2270 to be encoded. The visual data may be processed, for example, by the visual data coding module 2225, to generate an encoded bitstream. The encoded bitstream may be provided via the output device 2260 as an output 2280.

In the example embodiments of performing visual data decoding, the input device 2250 may receive an encoded bitstream as the input 2270. The encoded bitstream may be processed, for example, by the visual data coding module 2225, to generate decoded visual data. The decoded visual data may be provided via the output device 2260 as the output 2280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
obtaining, for a conversion between visual data and a bitstream of the visual data with a neural network (NN)-based model, a format for coding the visual data, the format indicating a relationship between a size of a first component of the coded visual data and a size of a second component of the coded visual data, and a first synthesis transform in the NN-based model being used for the first component;
determining, based on the format, a second synthesis transform in the NN-based model that is used for the second component; and
performing the conversion based on the first synthesis transform and the second synthesis transform.

2. The method of claim 1, wherein the first synthesis transform is the same for different formats.

3. The method of claim 1, wherein the second synthesis transform comprises an upsampling subnetwork, and at least one parameter of the upsampling sub-network is configured based on the format.

4. The method of claim 3, wherein the at least one parameter of the upsampling subnetwork is configured differently for different formats, or
wherein the upsampling subnetwork comprises a shuffle layer, and the at least one parameter comprises at least one scale factor of the shuffle layer, or
wherein the second synthesis transform further comprises a first subnetwork preceding the upsampling subnetwork, and the first subnetwork comprises a latent combine block (LCB), or
wherein the second synthesis transform further comprises a second subnetwork following the upsampling subnetwork, and the second subnetwork comprises a cropping layer, and at least one parameter of the second subnetwork is configured based on the format.

5. The method of claim 1, wherein an input of the first synthesis transform is different from an input of the second synthesis transform.

6. The method of claim 5, wherein a vertical size of the input of the first synthesis transform is the same as a vertical size of the input of the second synthesis transform, and a horizontal size of the input of the first synthesis transform is the same as a horizontal size of the input of the second synthesis transform.

7. The method of claim 1, wherein an output of the second synthesis transform is a chroma component of reconstructed visual data.

8. The method of claim 1, wherein a size of an output of the second synthesis transform is determined based on the format.

9. The method of claim 8, wherein the size of the output of the second synthesis transform comprises at least one of a width or a height of the output of the second synthesis transform.

10. The method of claim 8, wherein the size of the output of the second synthesis transform is equal to a size of an output of the first synthesis transform, or
wherein the size of the output of the second synthesis transform is equal to a half of a size of an output of the first synthesis transform.

11. The method of claim 9, wherein if the format is a 4:4:4 format, the width of the output of the second synthesis transform is equal to a width of an output of the first synthesis transform, and the height of the output of the second synthesis transform is equal to a height of the output of the first synthesis transform, or
if the format is a 4:2:2 format, the width of the output of the second synthesis transform is equal to the width of an output of the first synthesis transform, and the height of the output of the second synthesis transform is equal to a half of the height of the output of the first synthesis transform, or
if the format is a 4:2:0 format, the width of the output of the second synthesis transform is equal to a half of the width of an output of the first synthesis transform, and the height of the output of the second synthesis transform is equal to a half of the height of the output of the first synthesis transform.

12. The method of claim 8, wherein the size of the output of the second synthesis transform is determined based on an indication obtained from the bitstream.

13. The method of claim 1, wherein the format is indicated by at least one indication in the bitstream.

14. The method of claim 3, wherein a ratio between a vertical size of the first component and a vertical size of the second component is allowed to be 2, and a ratio between a horizontal size of the first component and a horizontal size of the second component is allowed to be 2.

15. The method of claim 1, wherein the first synthesis transform comprises at least one of the following: a lightweight residual block (LRB), a convolution layer, a cropping layer, a residual activation unit (ResAU), or a shuffle layer, or
wherein the first component comprises one of the following: a primary component, a luma component, or a Y component, and the second component comprises one of the following: a secondary component, a chroma component, a U component, or a V component, or
wherein the format is allowed to be one of the following: a 4:4:4 format, a 4:2:0 format, or a 4:2:2 format, or
wherein the visual data comprise a video, a picture of the video, or an image.

16. The method of claim 1, wherein the conversion includes encoding the visual data into the bitstream.

17. The method of claim 1, wherein the conversion includes decoding the visual data from the bitstream.

18. The method of claim 1, wherein the conversion comprises: generating the bitstream from the visual data, and
the method further comprises: storing the bitstream in a non-transitory computer-readable recording medium.

19. An apparatus for visual data processing comprising a processor and a non-transitory memory with instructions thereon, wherein the instructions upon execution by the processor, cause the processor to perform operations comprising:
obtaining, for a conversion between visual data and a bitstream of the visual data with a neural network (NN)-based model, a format for coding the visual data, the format indicating a relationship between a size of a first component of the coded visual data and a size of a second component of the coded visual data, and a first synthesis transform in the NN-based model being used for the first component;
determining, based on the format, a second synthesis transform in the NN-based model that is used for the second component; and
performing the conversion based on the first synthesis transform and the second synthesis transform.

20. A non-transitory computer-readable storage medium storing instructions that cause a processor to perform operations comprising:
obtaining, for a conversion between visual data and a bitstream of the visual data with a neural network (NN)-based model, a format for coding the visual data, the format indicating a relationship between a size of a first component of the coded visual data and a size of a second component of the coded visual data, and a first synthesis transform in the NN-based model being used for the first component;
determining, based on the format, a second synthesis transform in the NN-based model that is used for the second component; and
performing the conversion based on the first synthesis transform and the second synthesis transform.
